(19) United States
(12) Patent Application Publication
(10) Pub. No.: US 2022/0333418 A1
(43) Pub. Date: Oct. 20, 2022

(54) PASSIVE HINGE WITH DOOR HOLDER

(71) Applicant: ROLLMECH AUTOMOTIVE SANAYI VE TICARET ANONIM SIRKETI, Bursa (TR)

(72) Inventors: Neslihan PARILDAR, Bursa (TR); Ilker DEMIRAYAK, Bursa (TR)

(73) Assignee: ROLLMECH AUTOMOTIVE SANAYI VE TICARET ANONIM SIRKETI, Bursa (TR)

(21) Appl. No.: 17/621,694

(22) PCT Filed: Apr. 3, 2020
(86) PCT No.: PCT/TR2020/050270

§ 371 Date: Dec. 22, 2021

(30) Foreign Application Priority Data
Jun. 26, 2019 (TR) 2019/09482

(51) Int. Cl. E05D 11/10; E05D 3/02; E05D 5/06

(52) U.S. Cl. CPC E05D 11/1057; E05D 11/1014; E05D 3/02; E05D 5/062; E05Y 2201/484; E05Y 2201/624; E05Y 2800/75; E05Y 2900/531

(57) ABSTRACT

A hinge with a door holder is provided. The hinge includes at least one fixed body connected onto a vehicle body, at least one movable body connected to a vehicle door and an axis pin, wherein the axis pin provides connecting of the at least one movable body and the at least one fixed body to each other in a rotatable manner.

### CROSS REFERENCE TO THE RELATED APPLICATIONS

This application is the national stage entry of International Application No. PCT/TR2020/050270, filed on Apr. 3, 2020, which is based upon and claims priority to Turkish Patent Application No. 2019/09482 filed on Jun. 26, 2019, the entire contents of which are incorporated herein by reference.

### TECHNICAL FIELD

The present invention essentially relates to a hinge used in vehicles. The present invention particularly relates to a hinge with door holder used at rear cargo doors of vehicles and which provides stopping of the door at a predetermined intermediate step.

### BACKGROUND

Today, in automotive sector; hinges are used which have various functions and which connect vehicle doors and vehicle body to each other. There are hinges which provide one-sided or two-sided opening or closing by making circular movements at specific angles in the axes of points connected to the vehicle body without completely separating from the vehicle body. These hinge systems can be used in parts like tailgates, rear doors, front doors, sunroofs or in all parts of the vehicles which need an openable-closeable mechanism.

The door holders (torque arms), existing in the present art, prevent the door, where no force is applied or where no intervention is made while the doors are in open position, from opening excessively or closing in an undesired manner. When a specific force is exerted to the door or when the door holder is intervened manually, the door is further opened. The door continues to open in a stepped manner, at angle and number which change according to force or intervention. In this case, the door can be opened in a stepped manner and can be closed in a stepped manner. Door holders are essentially mechanisms which comprise parts whose one part exists at the vehicle body or whose one part exists at the vehicle door.

In the present art, the hinge and the door holder are positioned in an independent manner from each other in vehicles. After the vehicle door is connected to the vehicle body by means of hinges, the door holder is assembled through the lower or upper part of the hinge. However, in order for the hinge and the door holder to be used at different locations, vehicle producers produce different connection housings on the door for the hinges and for the door holders. Moreover, the hinge and the door holder are screwed and connected to the door and to the body. Usage of two different materials for two different functions increases the part number. Thus, the durations of assembly made to the door and to the body extend and the cost increases. Therefore, excessive time loss and cost occur for the producers.

In the application with number TR 2013/03049 existing in the known state of the art, a hinge with holder is described, having at least one fixed body and at least one movable body which provide rotatable connection of the door with respect to the vehicle body. In the patent document, moreover, a hinge with door holder which has at least one lock element, placed to a seizure element assembled to any one of the fixed or movable bodies in order to delimit the opening amount of the door with respect to the vehicle body at a specific degree, is also disclosed. When the hinge with door holder mentioned in this application is moved in the direction of opening the door, the lock element engages to the seizure element and provides fixation of the door at that position without needing exertion of any force by the user. However, when the door is desired to be closed, the user has to manually lift said door holder element and release said door holder element from the lock element. Otherwise, the door does not automatically close. This leads to extra time loss and effort for the users who close the door.

As a result, improvements are made in hinges with door holders, and therefore, new embodiments, which eliminate the abovementioned problems and which bring solution to the present systems, are required in the related technical field.

### SUMMARY

The present invention relates to a hinge with door holder, for eliminating the above mentioned disadvantages and for bringing new advantages to the related technical field.

The main object of the present invention is to provide a passive hinge with door holder which does not need realization of a process on the hinge or effort consumption during opening or closing of the rear cargo door by users.

An object of the present invention is to provide a hinge with door holder which can provide the functions of hinges and door holders together.

Another object of the present invention is to provide a hinge with door holder for decreasing the duration consumed for the assembly of hinges and door holders.

Another object of the present invention is to provide a hinge with door holder with reduced production and maintenance costs.

In order to realize the abovementioned objects and the objects which are to be deducted from the detailed description below, the present invention is a hinge with door holder comprising at least one fixed body connected onto a vehicle body, at least one movable body connected to the vehicle door and an axis pin which provides connecting of the movable body and the fixed body to each other in a rotatable manner, wherein the subject matter hinge with door holder has:
at least one delimiting bracket connected to the fixed body, in order to provide stopping of the vehicle door at an intermediate step with respect to the vehicle body,
at least one holder arm which moves by means of opening or closing of the vehicle door and connected on the movable body and which provides stopping of the vehicle door at an intermediate step,
at least one press spring which continuously keeps said holder arm under pressure and which prevents movement thereof in the opposite direction and whose one end contacts the movable body and whose other end contacts the holder arm,
at least one curved intermediate stopper connected on the fixed body, in order to provide stopping of the vehicle door at a determined intermediate step,
at least one recess placed on said curved intermediate stopper and at least one seizure element connected on the holder arm and which seats to said recess and which provides stopping of the vehicle door at a determined intermediate step.

The structural and characteristic properties and all advantages of the present invention will be understood in a more clear manner by means of the below mentioned figures and the detailed description written by making reference to these figures. Therefore, evaluation shall be made by taking into consideration these figures and the detailed description.

### BRIEF DESCRIPTION OF THE DRAWINGS

In order to understand the embodiment of the present invention and the advantages together with additional elements, they shall be evaluated together with the figures whose description is given below.

FIG. 1 is the isometric view of the closed position of the subject matter hinge with door holder.

FIG. 2 is the isometric view of the half-open position of the subject matter hinge with door holder.

FIG. 3 is the view of the subject matter hinge with door holder where said hinge with door holder comes to half-open position from the open position.

FIG. 4 is the isometric view of the open position of the subject matter hinge with door holder.

FIG. 5 is the dismantled view of the subject matter hinge with door holder.

FIG. 6 is the view of the half-open position of the subject matter hinge with door holder where said hinge with door holder is connected to the vehicle body and to the door.

### REFERENCE NUMBERS

1. Hinge with door holder

10. Fixed body

11. Base part

111. Assembly opening

12. Delimiting bracket

121. Guiding ramp

122. Extension arm

123. Arm delimiter

124. Connection hole

125. Fixation element

126. Assembly opening

13. Curved intermediate stopper

131. Recess

132. Gasket

133. Fixation bracket

134. Fixation element

135. Assembly opening

14. Arm part

141. Hinge flap

142. Axis pin

143. Bushing

144. Tap

20. Movable body

21. Base part

211. Assembly opening

212. Gasket

22. Arm part

221. Axis pin

222. Hinge flap

223. Axis hole

23. Door holder

231. Holder arm

232. Seizure element

233. Pin

234. Press spring

235. Bushing

30. Vehicle body

40. Vehicle door

### DETAILED DESCRIPTION OF THE EMBODIMENTS

In this detailed description, the preferred embodiments of the subject matter hinge (1) with door holder is explained with references to examples without forming any restrictive effect only in order to make the subject more understandable.

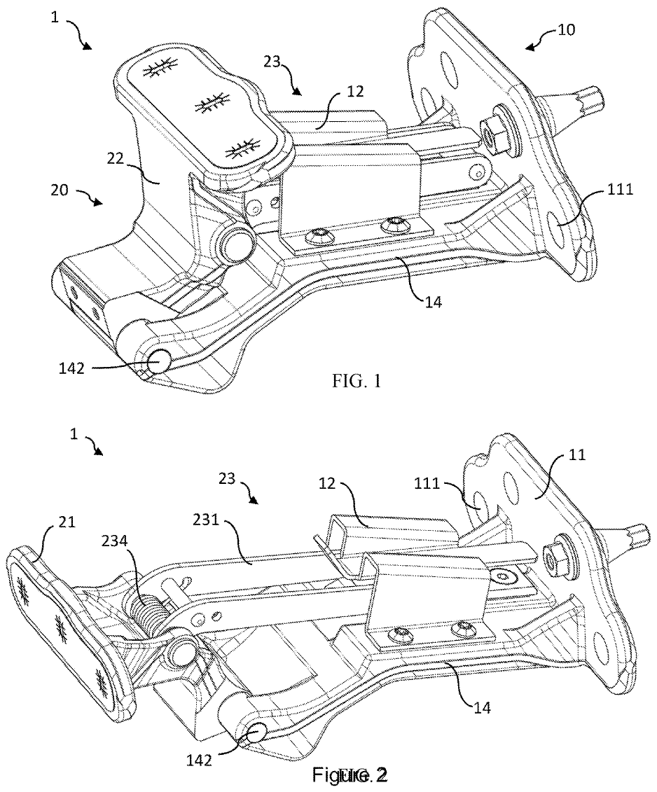

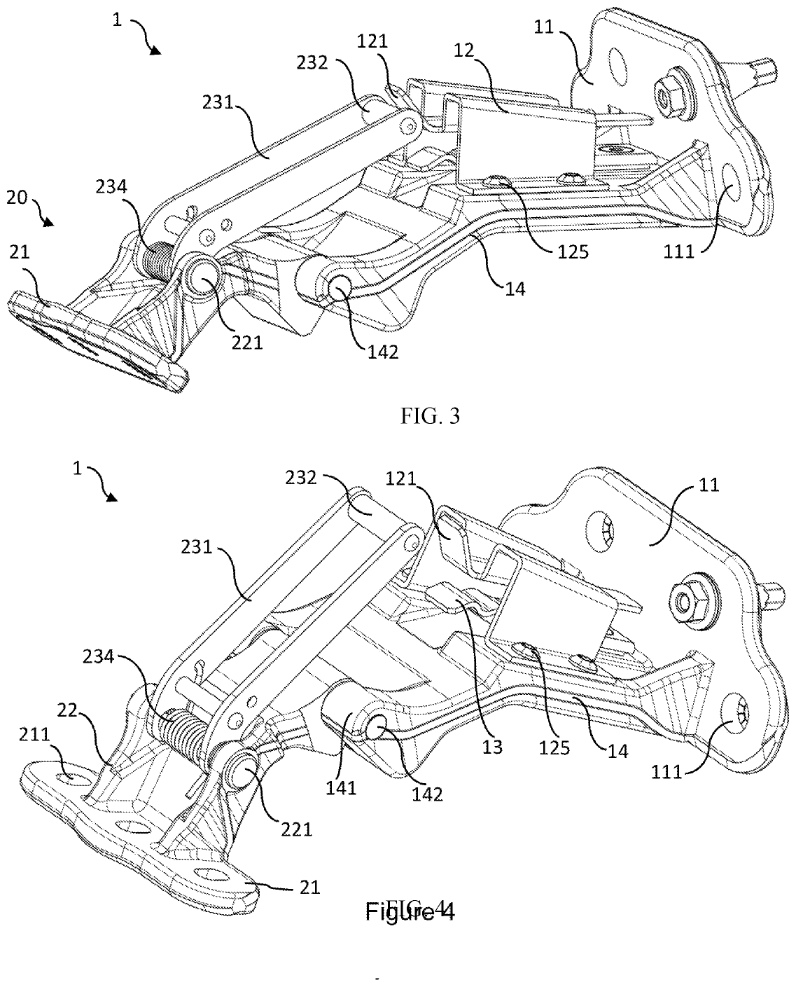

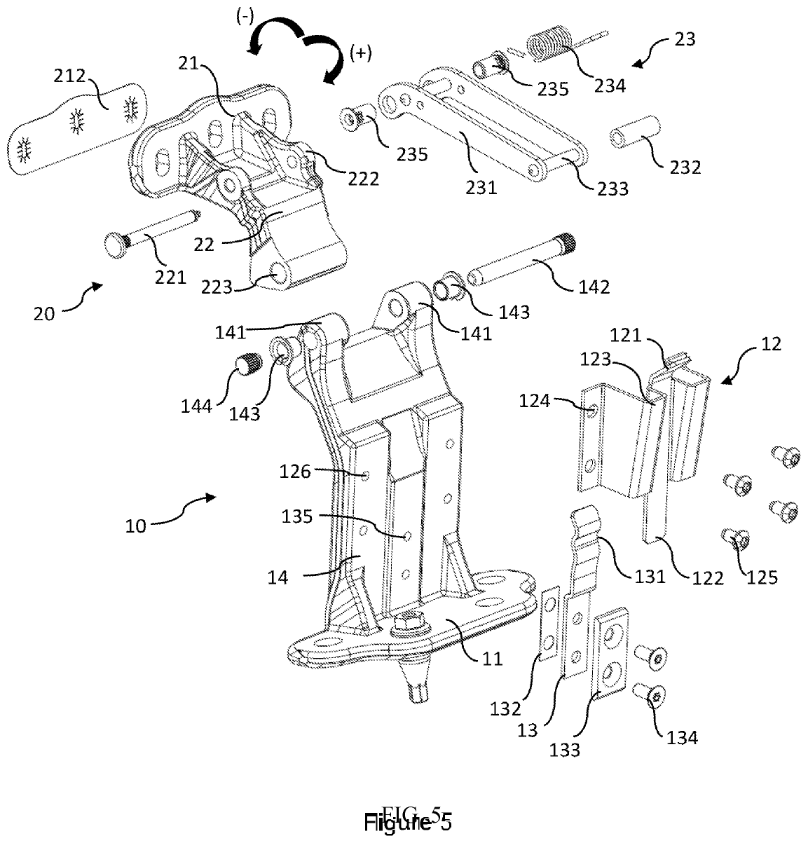

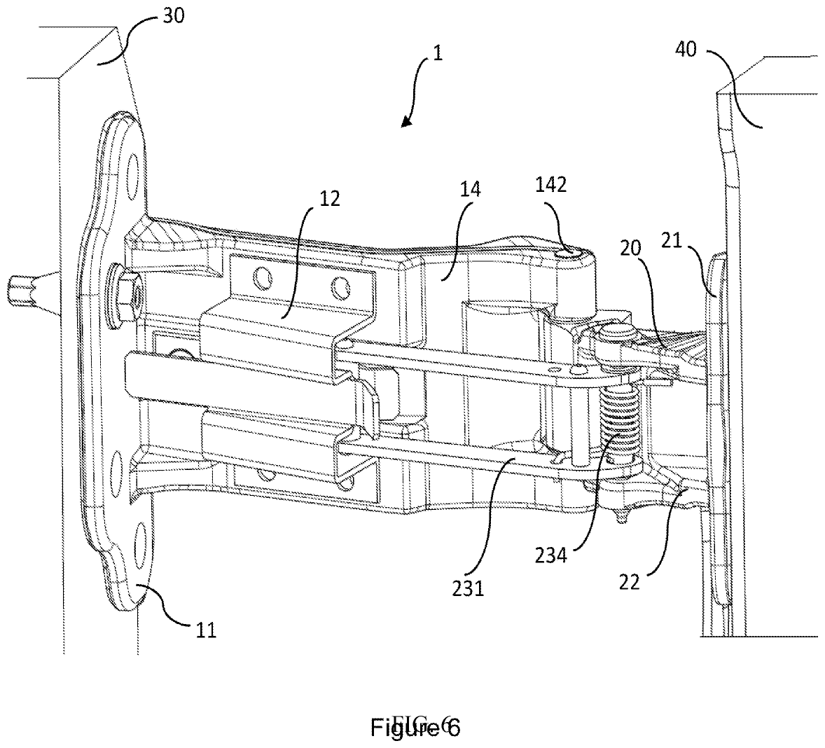

As can be seen in FIG. 1, a view of the hinge (1) with door holder in the closed position is given. In FIG. 2, the view of the hinge (1) with door holder in the half-open position is given.

As seen in FIG. 1 and FIG. 2, the subject matter hinge (1) with door holder basically comprises a fixed body (10) for being connected to the vehicle body (30), a movable body (20) for being connected to the vehicle door (40), and a door holder (23) which extends between the fixed body (10) and the movable body (20) in order to provide the vehicle door (40) to stay at a predetermined intermediate step while the vehicle door (40) is being opened or closed.

The fixed body (10) comprises a base part (11) for being connected to the vehicle body (30) and an arm part (14) which extends outwardly from the base part (11). On said base part (11), there is at least one assembly opening (111) through which a connection element can be passed for providing connection of the fixed body (10) to the vehicle body (30).

The movable body (20) comprises a base part (21) in order to be connected to the vehicle door (40), and an arm part (22) which extends outwardly from the base part (21). On said base part (21), there is at least one assembly opening (211) through which a connection element is passed for providing connection of the movable body (20) to the vehicle door (40). There is preferably a gasket (212) for providing sealing between the vehicle door (40) and the movable body (20).

Thanks to the door holder (23) where one connection is provided in the movable body (20) and where the other connection is provided in the fixed body (10), the vehicle door (40) is stopped in the predetermined intermediate step.

By means of the axis pin (142) passed through the axis hole (223) provided at the arm part (22) of the movable body (20) and through the hinge flap (141) of the fixed body (10), the movable body (20) is connected in a rotatable manner. In order for the rotation movement to be better and in order to decrease friction between the parts, preferably a bushing (143) is used between the axis pin (142) and the hinge flap (141). There is a tap (144) connected to the hinge flap (141) in a manner provided at the opposite direction to the connection direction of the axis pin (142) and in a manner preventing removal by means of an external effect.

The hinge flap (222), provided in the arm part (22) of the movable body (20), and the holder arm (231) are connected to the axis pin (221) in a rotatable manner. In order for the parts not to rub and wear as a result of the rotational movement of said holder arm (231), bushing (235) is used between the holder arm (231) and the hinge flap (222). In order to delimit the movement of the holder arm (231) in a single direction, there is at least one press spring (234) whose one end contacts the arm part (22) and whose other end contacts the holder arm (231). Thanks to this, the holder arm (231) tries to move in the (+) direction.

There is a pin (233) provided at one end of the holder arm (21) and there is the seizure element (232) connected onto said pin (23). The seizure element (232) is preferably made of plastic material with high resistance.

There is a curved intermediate stopper (13) connected to the arm part (14) of the fixed body (10). The recess (131) form provided in the structure of said curved intermediate stopper (13) is such that the seizure element (232) provided in the structure of the holder arm (21) can be placed. There is a fixation bracket (133) for providing rigidity at the arm part (14) of the curved intermediate stopper (13). The curved intermediate stopper (13) is preferably produced from spring steel. Preferably gasket (132) is used between the curved intermediate stopper (13) and the arm part (14) for preventing metal-metal contact. Said gasket (132), said curved intermediate stopper (13) and said fixation bracket (133) are fixed to the assembly opening (135) provided at the arm part (14) by means of at least one fixation element (134).

There is at least one delimiting bracket (12) which delimits the movement of the seizure element (232) on the curved main stopper (13) by being connected to the arm part (14) of the fixed body (10). The delimiting bracket (12) is connected to the arm part (14) by means of fixation elements (125) passed through the connection holes (124) existing thereon and through the assembly opening (126) provided on the arm part (14). As a result, assembly is realized such that a specific gap remains between the curved intermediate stopper (13) and the delimiting bracket (12) assembled on the fixed body (10).

There is a guiding ramp (121) provided at one end of the delimiting bracket (12) and which prevents collision of the seizure element (232) with the delimiting bracket (12) and which facilitates entry between the curved intermediate stopper (13) and the delimiting bracket (12). At the other end of the delimiting bracket (12), there is the extension arm (122). Said extension arm (122) is used for delimiting the movement of the seizure element (232) and for preventing the contact between the delimiting bracket (12) and the holder arm (12) in case of probable vibrations. Thus, noise is prevented and the abrasions and wearing are prevented and the lifetime of the part is extended. The arm delimiter (123) provided in the structure of the delimiting bracket (12) is formed in a manner providing movement of said holder arm (231).

As can be seen in FIG. 1, a view of the hinge (1) with door holder in the closed position of the vehicle door (40) is given. In FIG. 2, the view of the hinge (1) with door holder in the half-open position of the vehicle door (40) is given. Here, the base part (11) of the fixed body (10) connected to the vehicle body (30) and the base part (21) of the movable body (20) connected to the vehicle door (40) are preferably in parallel position. In case the vehicle door (40) is in the half-open position, it stays at an angle of approximately 90 degrees with respect to the vehicle body (30). When the movable body (20) goes from the closed position to the half-open position, the seizure element (232), provided on the holder arm (231), seats to the recess (131) provided on the curved intermediate stopper (13). The seizure element (232) stays between the delimiting bracket (12) and the curved intermediate stopper (13), and it can move again as it overcomes the holding force of the curved intermediate stopper (13). Therefore, when the vehicle door (40) comes to the half-open position from the closed position, since the seizure element (232) is going to seat to the recess (131) part, it is going to stay in this part. When the vehicle door (40) is desired to be opened from the half-open (approximately 90 degrees) position to the completely open (approximately 180 degrees) position, a force must be exerted on the vehicle door (40) where said force will release the seizure element (232) from the recess (131) wherein said seizure element (232) was seating. In order to close the vehicle door (40) again, it will be sufficient to exert force only to the vehicle door (40). Since the users do not have any action on the hinge (1) with door holder as the users are opening or closing the vehicle door (40), the usage thereof is substantially comfortable and ergonomic.

In alternative embodiments of the present invention, the holder arm (231) can be provided on the fixed body (10) instead of the movable body (20). In another alternative embodiment of the present invention, the delimiting bracket (12) and the curved intermediate stopper (13) can be provided on the movable body (20) instead of the fixed body (10). In alternative embodiments of the present invention, the holder arm (231), the seizure element (232), the delimiting bracket (12), the guiding ramp (121), the curved intermediate stopper (13) can be provided in different forms and structures.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

What is claimed is:

1. A hinge with a door holder, comprising at least one fixed body connected onto a vehicle body, at least one movable body connected to a vehicle door and an axis pin, wherein the axis pin provides connecting of the at least one movable body and the at least one fixed body to each other in a rotatable manner, wherein the hinge comprises
at least one delimiting bracket connected to the at least one fixed body to provide stopping of the vehicle door at an intermediate step with respect to the vehicle body,
at least one holder arm, wherein the at least one holder arm moves by opening or closing of the vehicle door and connected on the at least one movable body and the at least one holder arm provides the stopping of the vehicle door at the intermediate step,
at least one press spring, wherein the at least one press spring continuously keeps the at least one holder arm under pressure and prevents a movement of the at least one holder arm in an opposite direction and a first end of the at least one press spring contacts the at least one movable body and a second end of the at least one press spring contacts the at least one holder arm,
at least one curved intermediate stopper connected on the at least one fixed body to provide the stopping of the vehicle door at a determined intermediate step,
at least one recess placed on the at least one curved intermediate stopper and at least one seizure element connected on the at least one holder arm, wherein the at least one seizure element seats to the at least one recess and provides the stopping of the vehicle door at the determined intermediate step.

2. The hinge according to claim 1, wherein at least one guiding ramp is provided which to prevent colliding of the at least one seizure element, provided on the at least one holder arm, to the at least one delimiting bracket.

3. The hinge according to claim 1, wherein the at least one seizure element is made of a plastic material.

4. The hinge according to claim 1, wherein the at least one curved intermediate stopper is a material showing a spring characteristic.

5. The hinge according to claim 4, wherein the at least one curved intermediate stopper is preferably a spring steel.

6. The hinge according to claim 1, wherein the at least one curved intermediate stopper comprises at least one fixation bracket for providing a rigidity in an assembly of the at least one curved intermediate stopper to the at least one fixed body.

7. The hinge according to claim 1, comprising at least one tap, wherein the at least one tap is configured to provide a protection of the axis pin for connecting of the at least one movable body and the at least one fixed body to each other in the rotatable manner, and the at least one tap is connected to a hinge flap.

8. The hinge according to claim 1, comprising at least one pin, wherein the at least one pin provides connection of the at least one seizure element to the at least one holder arm.

9. The hinge according to claim 1, wherein at least one extension arm prevents a noise of the at least one seizure element, the noise results from vibrations, and the at least one extension arm is provided on the at least one delimiting bracket.

10. The hinge according to claim 1, wherein at least one arm delimiter delimiting a movement of the at least one holder arm, is provided on the at least one delimiting bracket.

11. The hinge according to claim 1, wherein the at least one fixed body and the at least one movable body are made of an aluminum material.

12. The hinge according to claim 11, wherein the at least one fixed body and the at least one movable body are made of 6xxx series aluminum material.
